(19) United States
(12) Patent Application Publication
(10) Pub. No.: US 2008/0238340 A1
(43) Pub. Date: Oct. 2, 2008

(54) METHOD AND APPARATUS FOR SETTING OPERATING CURRENT OF LIGHT EMITTING SEMICONDUCTOR ELEMENT

(76) Inventors: Shun Kei Mars Leung, Hong Kong (HK); Chin Tung Derek Lau, Hong Kong (HK); Chong Yiu Dennis Lui, Hong Kong (HK)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/674,156

(22) Filed: Mar. 26, 2007

(51) Int. Cl. H05B 37/02

(52) U.S. Cl. 315/297; 315/308

(57) ABSTRACT

A method of determining an operating current adjustment for a light emitting semiconductor element in order to generate a predetermined brightness includes applying a test voltage to the light emitting element, determining a corresponding test current through the light emitting element, and determining the operating current adjustment dependent on the determined test current and the applied test voltage.

### BACKGROUND OF THE INVENTION

The present invention relates to the field of illumination control, and in particular to the control of light emitting diodes.

The brightness or light output intensity of a light emitting diode (LED) or an array of LED's can vary in response to changing die temperature, aging and other factors, despite a constant current input. While it is possible to adjust the operating current in order to compensate for these factors, these brightness varying factors are not easy to measure, U.S. Pat. No. 6,448,550 and U.S. patent application no. 2005/0062446 use light sensors to measure the light intensity output or brightness from adjacent LED's in order to adjust their operating current. However such an implementation is expensive and complex.

It would be advantageous to have a less expensive and complex way to maintain LED brightness over time.

### BRIEF DESCRIPTION OF THE DRAWINGS

For the purpose of illustrating the invention, there are shown in the drawings embodiments which are presently preferred. It should be understood, however, that the invention is not limited to the precise arrangements and instrumentalities shown. Elements in the figures are illustrated for simplicity and clarity and have not necessarily been drawn to scale. In the drawings:

FIG. 1A is a schematic diagram illustrating the layout of a semiconductor based white light source device according to an embodiment of the present invention;

FIG. 1B is a schematic diagram illustrating a LED in accordance with an alternative embodiment of the present invention;

FIG. 2 is a schematic circuit diagram of a controlled illumination apparatus in accordance with an embodiment of the present invention;

FIG. 3 is a schematic circuit diagram of another embodiment of a controlled illumination apparatus in accordance with the present invention; and

FIG. 4 is a flow diagram showing operation of a testing phase prior to normal operation of the apparatus of FIG. 2.

### DETAILED DESCRIPTION OF EMBODIMENTS OF THE INVENTION

In general terms, the present invention provides a method for setting the operating current for a light emitting semiconductor element such as one or an array of LED's in order to generate a predetermined brightness despite changes in light output versus operating current characteristics due to age, temperature and other factors. Thus the method determines an operating current that is adjusted compared with the constant current normally specified in order to compensate for these factors.

In an embodiment of the invention, a predetermined test voltage is applied to the light emitting element and the corresponding test current through the light emitting element is measured. An adjusted operating current is then determined dependent on the determined test current, for example using a lookup table.

In another embodiment of the invention, additional test parameters are determined, for example temperature, in order to provide more accurate operating current adjustments.

In an embodiment of the invention, the test voltage and operating current (including adjustment) are implemented using a programmable power supply circuit, such as a DC-DC converter.

In another embodiment of the invention, the test current can be measured by measuring the voltage across a resistor having a predetermined resistance value and couple in series to the light emitting element.

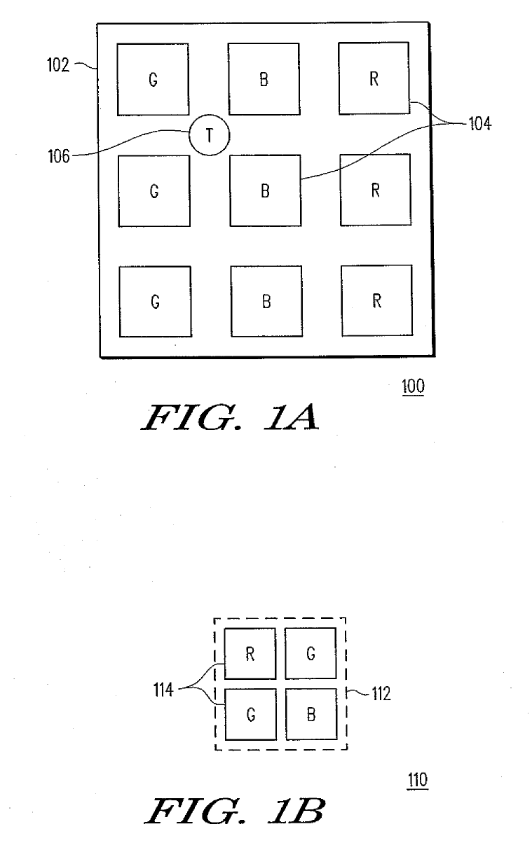

Referring now to the drawings, wherein like numbers refer to like elements, FIG. 1A shows the layout of a semiconductor based light source device or light emitting element 100 according to an embodiment of the invention. The device 100 comprises a common substrate 102 holding a number of light emitting diodes (LED's) 104. The LED's 104 may be of different colors, such as G-green, B-blue, and R-red, as shown, in order to be capable of generating a number of different color combinations. In a typical application, red, green and blue LED's 104 are mounted on the substrate 102 in order to generate a combined white light source device. White light source devices are typically employed for backlighting of LCD screens in electronic devices such as mobile phones, laptop computers, personal digital assistants (PDA's) and personal media players. Proper operation of the LCD screen typically requires a constant or predetermined brightness level from the LED white light source device or array of such devices. Variations in the brightness or light intensity output level will result in variations in brightness and other visual artefacts on the LCD screen that may be noticeable to a user of the electronic device.

As noted above however, variations in brightness of the LED 104 can occur due to temperature and aging effects, despite a constant operational current through the LED 104. In one embodiment, the operational current applied to the LED 104 is varied to compensate for brightness variations Measurements of certain operational test parameters of the LED 104 and/or device 100 are obtained to determine an adjustment of the operating current required in order to maintain a predetermined brightness.

The device 100 also comprises a temperature sensor 106 in this embodiment, which is typically also mounted on the substrate 102 adjacent the LED's 104. Alternatively the temperature sensor 106 may be located proximate the substrate 102, or omitted altogether in some embodiments. The particular layout of the LED's 104 on the substrate 102 may be varied, including the number and combination or arrangement of colored LED's, according to designer requirements as would be understood by those skilled in the art. In FIG. 1A, the device 100 includes three rows and three columns of LEDs 104, where each of the rows has one green, one red and one blue LED and each column comprises a single color LED. As will be understood by those of skill in the art, the number and arrangement of the LEDs may vary. For example, FIG. 1B shows an alternative embodiment of a light emitting element 110 comprising a substrate 112 having a 2×2 matrix of LEDs 114 formed thereon. The LEDs 114 are arranged as red and green in the top row and then green and blue in the bottom row. Thus, it is not required that LEDs of like color reside in the same column.

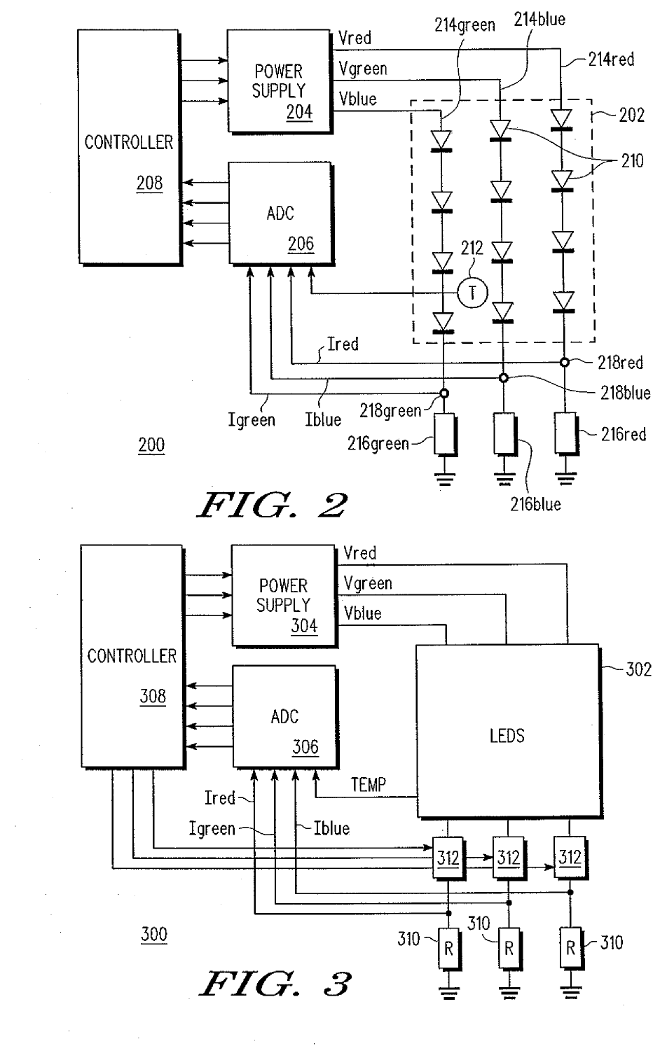

Referring now to FIG. 2, a circuit diagram of a controlled illumination apparatus 200 is shown. The illumination apparatus 200 includes an illumination device 202 (shown in dashed lines), a programmable power supply 204, an analog-to-digital converter (ADC) 206, and a controller 208. The illumination device 202 includes a number of LEDs 210 and a temperature sensor 212. The LEDs 210 are arranged as three series LED circuits 214, indicated as 214green, 214blue and 214red, these being typically grouped by the color of the LED 212. That is, a column of green LEDs, a column of blue LEDs and a column of red LEDs, where the LEDs of each column are connected in series. In the embodiment shown, each series circuit 214 has four of the LEDs 210. Although each LED circuit 214 comprises four LED's 210, different numbers of LED's can be connected in series, including just a single LED. The temperature sensor 212 is located adjacent to the green series circuit 214 green. Although only one temperature sensor is shown, the illumination device 202 may include more than one temperature sensor. For example, a temperature sensor could be included for each color or one for each of a predefined number of areas across which the LEDs 210 are distributed. The illumination device 202 is similar to the light emitting element 100 shown in FIG. 1A and discussed above.

The LEDs 210 are supplied from the programmable power supply 204, which provides power to the three series LED circuits 214green, 214blue and 214red. In one embodiment, the power supply 204 is a programmable DC-DC converter and in another embodiment, the power supply 204 is a constant current controller. In normal operation, the power supply 204 provides a constant current to each series LED circuit 214 such that each LED 210 has a predetermined operating current applied thereto. The predetermined operating current corresponds to a brightness or light intensity output level for the LED's 210, and this operating current will vary depending on the color of the LED 210, the manufacturer and other variables as is known. Thus for a given LED 210, the operating current will be known for a particular brightness level, and can be programmed into the programmable power supply 204 and/or constant current controller. Various suitable programmable DC-DC converters will be known to those skilled in the art Alternatively a different power supply arrangement could be used as would be appreciated by those skilled in the art,

Resistors 216, indicated individually as 216green, 216blue and 216red, are connected in series between each series LED circuit 214 and ground. Nodes 218 (i.e., 218green, 218blue and 218red) are formed between the series circuits 214 and the resistors 216. The ADC 206 is coupled to each of the nodes 218green, 218blue and 218red The ADC 206 also receives an input from the temperature sensor 212. If there is more than one temperature sensor, then the ADC 206 receives inputs from each of the temperature sensors.

The controller 208, which may be a microprocessor executing a software program or an application specific IC (ASIC) implementing an algorithm (e.g., an analog controller with specific logic and an integrated analog voltage and/or current measuring device or an analog controller with specific logic and an interface to the ADC 206), is connected to the power supply 204 and the ADC 206. The controller 208 receives inputs from the ADC 206, which are digital values for the ADC inputs, and generates output signals that control the output of the power supply 204.

In order to compensate for variations in brightness due to temperature and aging of the LED's 210, various operating or test parameters are measured during a test phase. During the test phase, a constant test voltage is applied by the programmable power supply 204 to the illumination device 202 or each LED circuit 214.

During the test phase, a respective test voltage (Vred, Vgreen, Vblue) is applied to each LED circuit (212red, 212green, and 212blue respectively), and the voltage at the series resistor nodes 218green, 218blue and 218red is measured by the ADC 206. The voltage measured in each case is compared with the ground voltage in order to provide a voltage value at the respective nodes 218green, 218blue and 218red. The particular test voltage applied depends on a number of factors including the LED manufacturer, LED color, and the number of LED's 210 in each LED circuit 212. The test voltage should be sufficient to ensure normal conduction of the LED's 210. Typically the test voltage will be that required to provide an operating current through the respective LED circuit 212, knowing the resistance values of the series resistors 216 and LED's 210 in each circuit 212, in order to provide the required brightness levels under nominal temperature and aging conditions. Other factors may be taken into account in order to set the test voltage as would be understood by those of skill in the art, for example, the temperature as measured by the temperature sensor and lot data provided by the manufacturer.

The test phase may be incorporated as part of the normal operation of the illumination apparatus 200. In this case, the voltage required to generate the operating current for the LEDs 210 for their current brightness level will be known or measurable by the controller 208 and the measured value can be used as the test voltage.

By applying a predetermined or otherwise known voltage across the series resistors 214 of each LED circuit 214, and knowing the resistance values of the series resistors 216, a measured current through the series resistors 216 and hence the corresponding LED circuits 214 can be determined. The measured test current corresponds to entries in a look-up table comparing test current values against an operating current adjustment required to compensate for reduced brightness levels due to temperature and aging effects. More accurate operating current adjustment values can be obtained by also including the temperature reading from the temperature sensor 212, which can then be incorporated into an enhanced look-up table. In an alternative arrangement, an algorithm may be used instead of the look-up table. In a further alternate embodiment, the lookup table or algorithm may provide operating current adjustment values that are used to adjust the normal operating current in order to compensate for the brightness altering factors previously mentioned.

Once the operating current is determined, the control algorithm implemented in the controller 208 controls the power supply 204 to provide a constant current for normal operation of the LEDs 210. The constant current is the normal operating current required or specified for a specific brightness level of the LEDs 210 together with the additional operating current adjustment value. Providing the modified or adjusted operating current generates the desired brightness level of the LEDs 210 despite the effects of aging and temperature.

FIG. 3 is a schematic diagram of a controlled illumination apparatus 300 in accordance with another embodiment of the present invention. The illumination apparatus 300 includes an LED array 302 like the LED array 202 in FIG. 2, a power supply 304, an ADC 306 and a controller 308. Like the apparatus 200, the power supply 304 provides voltage signals Vr, Vg and Vb (one each for red, green and blue) to the LED array 302; the ADC 306 receives one or more temperature signals from the LED array 302 as well as current Ir, Ig and Tb (one each for red, green, and blue), and converts these analog signals to digital signals and provides the digital signals to the controller 308. The apparatus also includes a plurality or resistors 310, one connected in series with each of the LED series circuits red, blue and green. However, connected between the resistors 310 and the LED array 302 are respective constant current controllers 312. The constant current controllers 312 are also connected to the controller 308.

In this embodiment, at start up, a calibration is performed by maintaining the DC-DC outputs to each color circuit of the LED array 302 constant (i.e., the voltages Vr, Vg and Vb from the power supply 304). The output currents Ir, Ig and Ib are then measured with the constant current controllers 312 fully turned on. Then, in operation, a control algorithm using the currents Ir, Ig and Ib and the temperature from the temperature sensor is used to feedback a signal to the constant current controllers 312 in order to maintain substantially constant operating currents Ir, Ig and Ib. The feedback information generated by the controller 308 can also be applied to the power supply 304 to apply additional control over the voltages applied to the LED array 302.

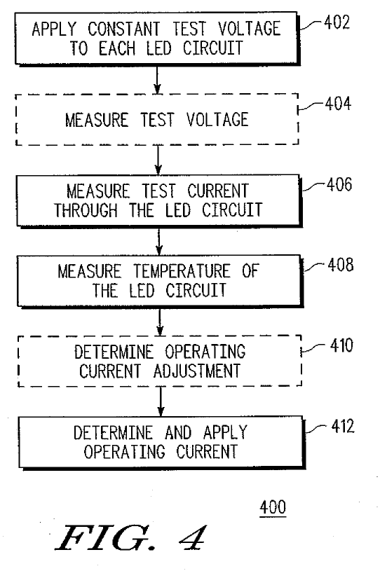

A method 400 of operating the controlled illumination apparatus 200 or each LED 210 according to an embodiment of the invention is illustrated in FIG. 4. The method 400 may be implemented in the controller 208 in order to control operation of one or more LEDs 210. For simplicity the method 400 is described with respect to the LED apparatus 200 of FIG. 2, which has three LED circuits, 214green, 214red, and 214blue. However, other LED arrangements could be operated in the same or a similar manner as would be appreciated by those skilled in the art.

At a step 402, during a test phase, a constant test voltage is applied to an LED 210 or LED circuit 214. The test voltage will vary depending on the type of LED, its color and manufactured specifications, and the number of LED's connected in series where a circuit is implemented as would be appreciated by those skilled in the art. The test voltage is sufficient to generate a current through each LED 210; that is the voltage applied across each LED 210 exceeds the LED's threshold voltage and preferably corresponds to a normal operational part of the LED's characteristic IV curve.

The initial test voltage application step 402 may be performed prior to initial start-up or “turn-on” of the LEDs 210 under normal illumination mode with a normal operating current, or periodically during normal illumination mode in order to correct for changes in brightness due to for example temperature changes as the LED's heat up under normal operating conditions. In this case, the test phases may be timed in order to minimise the user detectable impact on their application. For example, where each LED 210 is used for backlighting an LCD display screen, the testing phase may be implemented during a period when the screen is darkened or in a rastering display arrangement between screen refreshes. Alternatively, the testing phase may be performed continuously or periodically, with the present voltage output associated with the present constant operating current output of the power supply 204 being considered as the test voltage. The current through the series resistors 216 is measured to determine the test voltage and used to determine a new constant operating current for the LED circuits 214. Thus, the operating current for the LED circuits 214 can be continuously updated.

Where multiple LED circuits 214 are implemented in the controlled illumination device 200, the method 400 is applied to each LED circuit 214 separately (i.e., 214red, 214green and 214blue) and in a sequential manner where the same power supply 204 supplies each of the different LED circuits 214. Alternatively, the operating current and test voltages may be applied independently to each LED circuit 214. As noted above, the test or predetermined voltage Vgreen applied to the green LED circuit 214green may be different than the test voltage Vred applied to the red LED circuit 214red for example.

Following application of the test voltage to the LED circuits 214, the test voltages may be independently confirmed by independent measurement at step 404, for example, where the test voltage is simply the voltage (e.g., Vgreen) at the output of the power supply 204 required to generate the operating current Igreen for the LED circuit 214green under normal operating conditions.

The method 400 then measures the test currents Ired, Igreen, Iblue through the LEDs 210 resulting from the applied test voltages Vred, Vgreen, Vblue, respectively, at step 406. In the example implementation of FIG. 2, the test current (e.g., Ired) is measured by measuring the voltage at the node 218red connected between the LED 210, or last LED in a series LED circuit 214red, and a series resistor 216red. Knowing the resistance value of the series resistor 216red, the current (e.g., Ired) and hence the current through the corresponding LED 210 or LED circuit 214red can be calculated as Ired=V(21red)/R(216red). The voltage at the node 218red can be measured and converted using the ADC 206. In an alternative arrangement, other current sensor arrangements could be used, for example magnetic sensing or with a current to voltage amplifier.

Once the test current for the LED 210 or LED circuit 214 under test is determined at step 406, the temperature of the LED 210 or LED circuit 214 is measured at step 408, by measuring the voltage output (or some other parameter) with the temperature sensor 212 located adjacent or near the LED 210 or LED circuit 214 under test. Again, the temperature value may be converted to a digital value using the ADC 206.

The method 400, having determined all the test parameters required in this embodiment (e.g., Vred, Ired, and temperature) then determines an operating current adjustment at step 410. The operating current adjustment is dependent on the determined test current Ired, Igreen, or Iblue and in this embodiment the LED temperature reading from the temperature sensor 212. The operating adjustment value may be obtained from a lookup table or a suitable algorithm, using the test parameters as inputs. The operating adjustment current is the additional (or reduction in) current required compared with the normal operating current specified by the LED manufacturer to generate a particular brightness or light intensity output from the LED. Thus the LED current required to provide that brightness will vary depending on the temperature, age and other factors relating to the LED, and the lookup table or algorithm provides the required adjustment.

A number of lookup tables may be embodied in the apparatus 200 in order to provide for adjustment of the normally specified operating current for a number of different brightness levels. For a predetermined brightness value for a particular LED color, manufacturer and other specifications, the corresponding lookup table provides operating current (or adjustment) values for each measured or determined test current (Ired), and for each measured temperature (temp).

The particular operating current adjustment (or indeed the adjusted operating current) for a particular brightness will typically be different for different types, colors, and manufactures of LEDs. However these values may be determined experimentally, for example using a variable current source connected to the LED, a light output detector and a temperature sensor.

Where an operating current adjustment is determined at step 410, the normal operating current for achieving the desired brightness from the LED is adjusted by this amount at step 412; for example by reprogramming the power supply 204 powering the LED under normal illumination operating conditions. The power supply 204 then provides an adjusted or determined operating current that compensates for the effects of aging and temperature for example on the LED 210, and generates the required brightness from the LED 210.

The method 400 may be repeated for each of a number of LEDs 210 or LED circuits 214 within an illumination device 202 Where the device 202 is required to provide a varying light output rather than a static output as is typical in LCD backlighting applications, the adjusted operating current to generate the different light output may need to be calculated or looked up for each different light output setting. Thus, the method 400 may be repeated for each light setting possibly with different test voltage settings, and lookup tables or algorithms as would be appreciated by those skilled in the art.

Whilst white light source devices 100/110/202/302 or light emitting elements have been described, single color elements comprising one or a plurality of light emitting diodes or other semiconductor devices could be used. Similarly, whilst the devices 100/202 or elements have been described with reference to LCD backlighting applications, many other applications are also contemplated.

The skilled person will recognise that the above-described apparatus and methods may be embodied as processor control code, for example on a carrier medium such as a disk, CD- or DVD-ROM, programmed memory such as read only memory (firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A method of determining an operating current adjustment for a light emitting semiconductor element in order to generate a predetermined brightness; the method comprising:
applying a test voltage to the light emitting element;
determining a corresponding test current through the light emitting element;
determining the operating current adjustment dependent on the determined test current.

2. The method of determining an operating current adjustment of claim 1, further comprising measuring a temperature associated with the light emitting element and determining the operating current adjustment dependent on the measured temperature.

3. The method of determining an operating current adjustment of claim 1, wherein determining the test current through the light emitting semiconductor element comprises measuring a voltage across a series resistor.

4. The method of determining an operating current adjustment of claim 1, wherein determining the operating current adjustment comprises using a look-up table.

5. The method of determining an operating current adjustment of claim 1, wherein the light emitting semiconductor element comprises an array of light emitting diodes.

6. A method of operating a light emitting element in order to generate a predetermined brightness, the method comprising:
applying a test voltage to the light emitting element;
determining a corresponding test current through the light emitting element;
measuring a temperature associated with the light emitting element;
determining an operating current adjustment dependent on the determined test current, the applied test voltage, and the measured temperature; and
applying a constant current to the light emitting element, the constant current comprising an operational current associated with the predetermined brightness and the operating current adjustment.

7. A circuit for setting an operating current of a light emitting semiconductor element, comprising:
a power supply circuit for applying a test voltage to the light emitting semiconductor element;
a current sensor for determining a test current through the light emitting element in response to the applied test voltage; and
a controller arranged to determine an operating current adjustment dependent on the determined test current.

8. The operating current setting circuit of claim 7, further comprising a temperature sensor for measuring a temperature associated with the light emitting semiconductor element, and wherein the controller is further arranged to determine the operating current adjustment dependent on the measured temperature.

9. The operating current setting circuit of claim 7, wherein the controller is further arranged to apply a constant current to the light emitting element which comprises an operational current associated with a predetermined brightness of the light emitting semiconductor element and the operating current adjustment.

10. The operating current setting circuit of claim 9, wherein the power supply circuit is a DC-DC converter controllable to provide the test voltage and the constant current.

11. The operating current setting circuit of claim 7, wherein the current sensor is an analog-to-digital converter coupled to a resistor connected in series with the light emitting semiconductor element.
